(19) United States
(12) Patent Application Publication
(10) Pub. No.: US 2026/0042288 A1
(43) Pub. Date: Feb. 12, 2026

(54) PRINTING APPARATUS

(71) Applicant: CANON KABUSHIKI KAISHA, Tokyo (JP)

(72) Inventor: KOICHI SERIZAWA, Kanagawa (JP)

(21) Appl. No.: 19/286,335

(22) Filed: Jul. 31, 2025

(30) Foreign Application Priority Data
Aug. 6, 2024 (JP) 2024-129899

(51) Int. Cl. B41J 2/045

(52) U.S. Cl. CPC B41J 2/0455; B41J 2/04541; B41J 2/04573; B41J 2/04581; B41J 2/04588

(57) ABSTRACT

A printing apparatus has: a print unit configured to print by driving a piezoelectric element and ejecting ink; a generation unit including a plurality of digital-to-analog converters and configured to generate a plurality of drive signals used to drive the piezoelectric element, the digital-to-analog converters being configured to convert a digital signal to an analog signal; a control unit configured to output a control signal for generating the drive signals to the generation unit and control generation of the drive signals by the generation unit; and a selection unit configured to select a particular one of the plurality of drive signals generated by the generation unit and outputs the particular drive signal to the print unit. In the generation unit, the control signal is shared by the plurality of digital-to-analog converters, and the plurality of digital-to-analog converters output output signals at different timings.

### BACKGROUND

### Field of the Technology

The present disclosure relates to a printing apparatus using piezoelectric elements.

### Description of the Related Art

With the improvement in the quality of images printed by printing apparatuses in recent years, it is becoming a typical practice to aim for stable ejection performance by preparing a plurality of drive signals to supply to a printhead and using a different one of the plurality of prepared drive signals depending on, e.g., the characteristics of ink or the status of a nozzle configured to eject the ink. For example, in a printing apparatus configured to eject ink using piezoelectric elements and the inkjet method, a drive signal selection part is disposed near a piezoelectric element to select one of the drive signals and apply the drive signal selected by the drive signal selection part to the piezoelectric element.

Japanese Patent Laid-Open No. 2018-158494 discloses a technique where a drive circuit including a digital-to-analog converter obtains a drive signal by converting drive data, which is a digital signal being the basis of the drive signal, to an analog signal and amplifying the voltage and current of the converted analog signal.

However, in the technique disclosed in Japanese Patent Laid-Open No. 2018-158494, in order to generate a single drive signal, drive data in a plurality of bits needs to be transmitted to the drive circuit. For example, in a case where drive data is 10-bit long and eight drive circuits are provided, 80 (=10×8) signal lines are needed between these drive circuits and a configuration for outputting drive data. This means that a circuit substrate requires a large area for the wiring of these signal lines, which hinders the circuit substrate from being compact in size.

### SUMMARY

The present disclosure has been made in view of the above problem and provides a technique contributing to reduction in the size of a circuit substrate.

A printing apparatus includes: a print unit configured to print by driving a piezoelectric element and ejecting ink; a generation unit including a plurality of digital-to-analog converters and configured to generate a plurality of drive signals used to drive the piezoelectric element, the digital-to-analog converters being configured to convert a digital signal to an analog signal; a control unit configured to output a control signal for generating the drive signals to the generation unit and control generation of the drive signals by the generation unit; and a selection unit configured to select a particular one of the plurality of drive signals generated by the generation unit and outputs the particular drive signal to the print unit, wherein in the generation unit, the control signal is shared by the plurality of digital-to-analog converters, and the plurality of digital-to-analog converters output output signals at different timings.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic configuration diagram of a printing apparatus;

FIG. 2 is a schematic configuration diagram of a chip unit;

FIG. 3 is a schematic configuration diagram of a printhead;

FIGS. 4A and 4B are diagrams showing wiring on a flexible electric wiring substrate;

FIGS. 5A and 5B are diagrams illustrating how a piezoelectric element is driven;

FIG. 6 is a block diagram showing the configuration of the printing apparatus;

FIG. 7 is a block diagram showing a functional configuration of an image processing part;

FIG. 8 is a diagram showing a relation between FIGS. 8A and 8B; FIGS. 8A and 8B are schematic configuration diagram of a drive signal selection part and a drive signal generation part;

FIG. 9 is a diagram showing signals transmitted by first serial communication;

FIG. 10 is a diagram showing the relation between the signals transmitted by the first serial communication and drive signals;

FIG. 11 is a diagram showing a residual vibration voltage;

FIG. 12 is a circuitry diagram of a residual vibration detection circuit;

FIG. 13 is a circuitry diagram of a drive signal generation circuit;

FIG. 14 is a diagram showing a detailed configuration of the drive signal generation part;

FIG. 15 is a diagram illustrating the timings of DAC control signals;

FIG. 16 is a diagram showing an example waveform of an output from a DAC;

FIGS. 17A to 17H are diagrams showing the relation between time and an output value from a DAC at a rising point of the output waveform;

FIGS. 18A to 18H are diagrams showing the relation between time and an output value from a DAC at a falling point of the output waveform;

FIG. 19 is a diagram showing a detailed configuration of a drive signal generation part according to a second embodiment; and

FIG. 20 is a diagram illustrating the timings of DAC control signals according to the second embodiment.

### DESCRIPTION OF THE EMBODIMENTS

Examples of embodiments of a printing apparatus are described in detail below with reference to the drawings attached hereto. Note that the following embodiments are provided with no intension of limiting the present disclosure, and not all the combinations of the features described in the embodiments herein are necessarily essential as solutions provided by the present disclosure. Also, the positions, shapes, and the like of constituents described in the embodiments are merely exemplary, and there is no intension of limiting the scope of the present disclosure only to them.

### First Embodiment

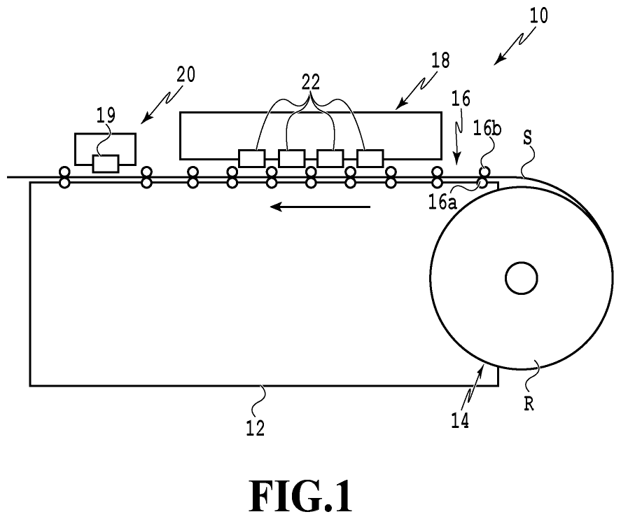

A printing apparatus according to a first embodiment is described with reference to FIGS. 1 to 18H. As an example of a printing apparatus of the present embodiment, the following describes a printing apparatus configured to print on a sheet (hereinafter referred to as a “printing medium”) unwound from a roll using a full-line-type printhead.

### <Printing Apparatus>

FIG. 1 is a schematic configuration diagram of the printing apparatus of the present embodiment. A printing apparatus 10 shown in FIG. 1 includes a casing 12, a holding part 14 configured to hold a roll R formed by a wound-up sheet-shaped printing medium S, and a conveyance part 16 configured to convey the printing medium S unwound from the roll R. The printing apparatus 10 also includes a head unit 18 configured to print on the printing medium S conveyed by the conveyance part 16, and a scanner unit 20 having a line scanner 19 configured to scan an image printed on the printing medium S by the head unit 18.

The head unit 18 includes full-line-type printheads 22 capable of printing on a region corresponding to the length of the conveyed printing medium S in terms of its width direction (a direction perpendicular to the paper plane of FIG. 1). In the present embodiment, four printheads are provided: one for ejecting cyan ink, one for ejecting magenta ink, one for ejecting yellow ink, and one for ejecting black ink. Note that the number of printheads and the types of ink ejected by the printheads are not limited to the above.

The conveyance part 16 conveys the printing medium S in a conveyance direction (see the arrow in FIG. 1) by nipping the printing medium S with a conveyance roller 16a driven by, for example, a motor and a slave roller 16b in pressure contact with and slave-driven by the conveyance roller 16a. The printheads 22 of the head unit 18 sequentially eject ink to the printing medium S conveyed by the conveyance part 16, thereby printing an image thereon.

### <Configuration of the Printheads>

The printheads 22 each include nozzles configured to eject ink. The printhead 22 includes piezoelectric elements as ejection energy generating elements configured to cause ink to be ejected from the nozzles. To eject ink, a piezoelectric element is used to generate a pressure inside a pressure chamber, and the pressure causes a liquid in the pressure chamber to be ejected from a nozzle formed at an end of the pressure chamber. In other words, in the printhead 22, each piezoelectric element has an electric contact and is connected to an integrated circuit configured to generate a drive signal, and the printhead 22 ejects ink by driving the piezoelectric element using a drive signal. The following describes the configuration of the printhead 22.

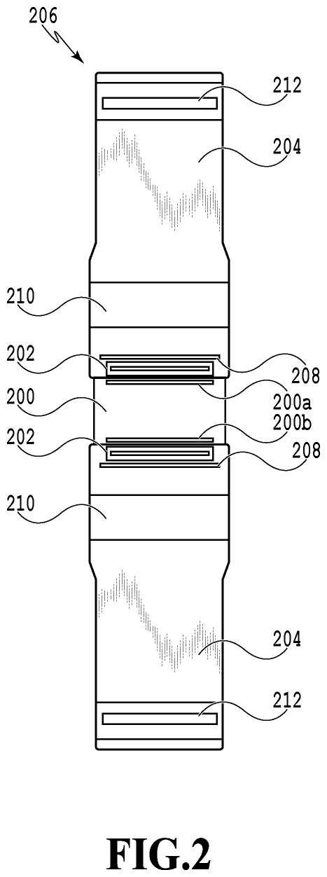

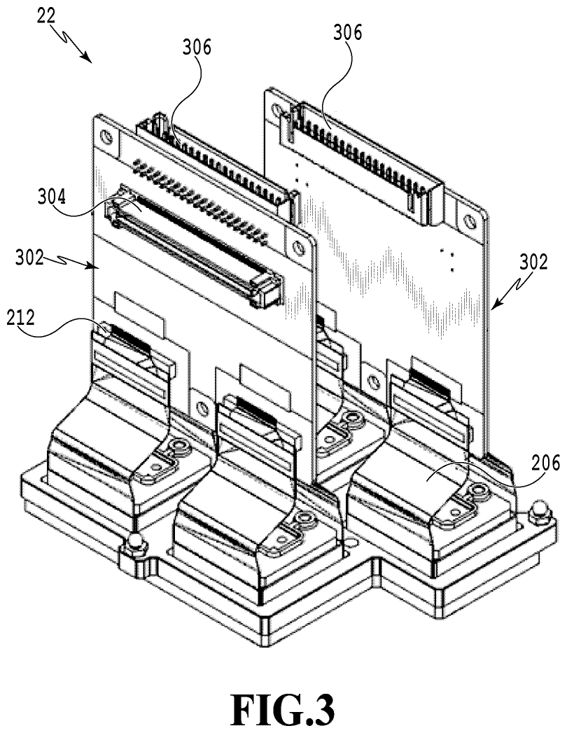

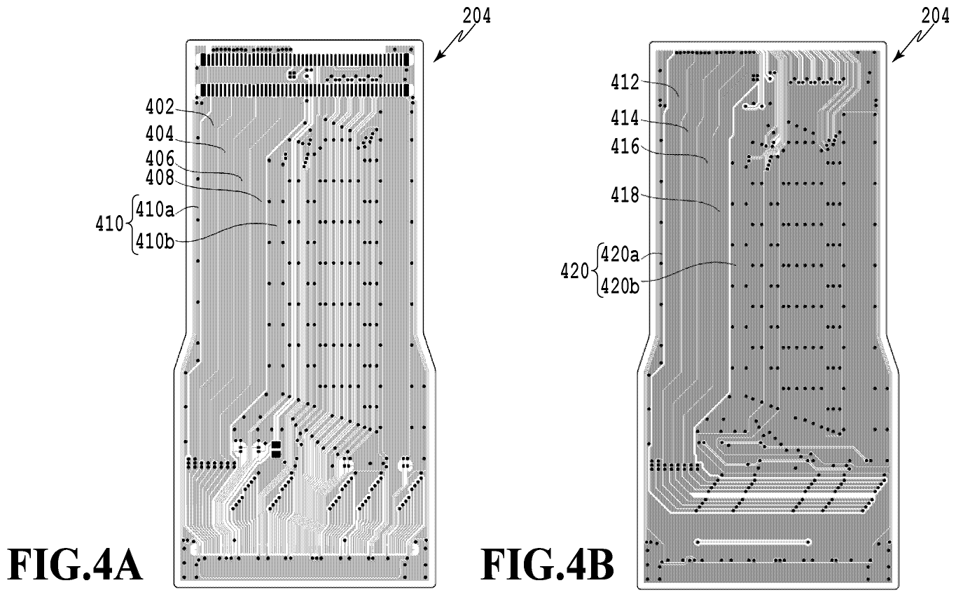

FIG. 2 is a schematic configuration diagram of a chip unit 206 provided at the printhead 22. FIG. 3 is a schematic configuration diagram of the printhead 22. FIGS. 4A and 4B are diagrams showing wiring on a flexible electric wiring substrate 204, FIG. 4A showing a first layer, FIG. 4B showing a second layer.

The chip unit 206 has a piezoelectric element substrate 200, drive signal selection parts 202, and flexible electric wiring substrates 204. The piezoelectric element substrate 200 has piezoelectric elements, pressure chambers, and nozzles and is configured to be able to eject ink. Note that publicly known technique can be used for specific configurations of the piezoelectric element, the pressure chamber, and the nozzle, and their detailed descriptions are omitted here. Note that a description will be given later about how the piezoelectric element is driven.

The piezoelectric element substrate 200 is provided with a first terminal 200a near one end portion in terms of its shorter-side direction (the up-down direction in FIG. 2) and a second terminal 200b near the other end portion in terms of the shorter-side direction (see FIG. 2). The first terminal 200a and the second terminal 200b are respectively electrically connected to terminals (not shown) provided at the drive signal selection parts 202 implemented on the flexible electric wiring substrates 204.

The flexible electric wiring substrate 204 has a selection-part-side terminal 208 and is electrically connected to a wiring-substrate-side terminal (not shown) provided at the drive signal selection part 202. Also, the flexible electric wiring substrate 204 has a capacitor mount part 210 configured to implement a power-source bypass capacitor for the drive signal selection part 202 and a head substrate connection part 212 connected to a head substrate 302 (see FIG. 3).

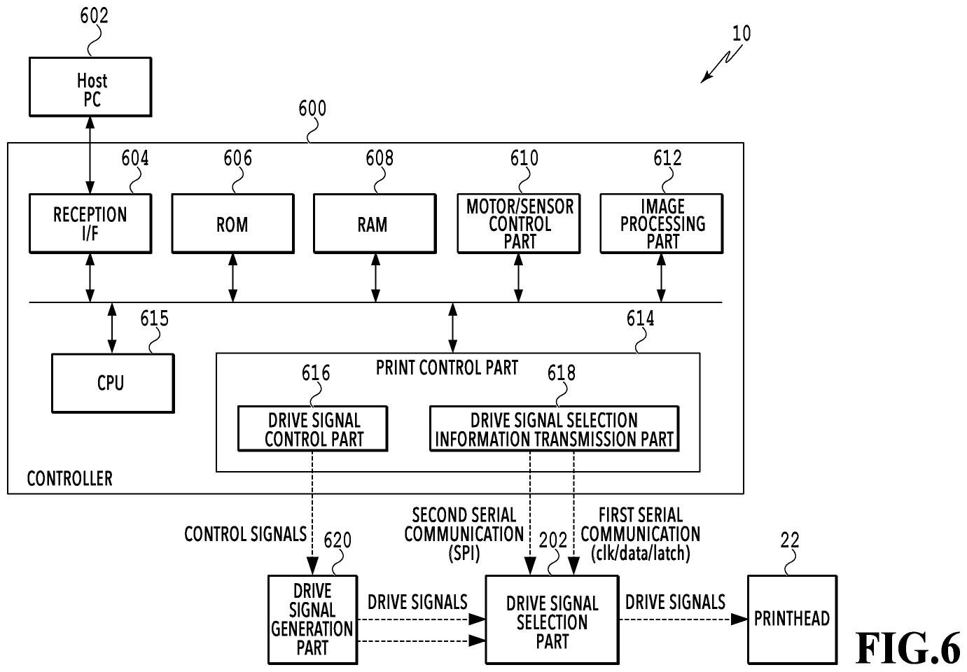

The printhead 22 has four chip units 206 (see FIG. 3). Each of the chip units 206 is electrically connected to the head substrate 302 via the head substrate connection part 212. Note that for example, the head substrate 302 has a signal connection part 304 and a drive signal connection part 306 connected to a controller 600 (see FIG. 6) configured to control the printing apparatus 10.

The flexible electric wiring substrate 204 has a first layer formed on one of the surfaces of a base material (see FIG. 4A) and a second layer formed on the other surface of the base material (see FIG. 4B). Formed at the first layer of the flexible electric wiring substrate 204 are a first drive signal wire 402, a third drive signal wire 404, a fifth drive signal wire 406, and a seventh drive signal wire 408, and these wires have almost the same wiring width (see FIG. 4A). The first drive signal wire 402, the third drive signal wire 404, the fifth drive signal wire 406, and the seventh drive signal wire 408 are arranged side by side in this order in the width direction of the flexible electric wiring substrate 204 intersecting with the direction in which the flexible electric wiring substrate 204 extends. Then, these drive signal wires are disposed in such a manner as to be sandwiched by two drive signal feedback current wires 410 in the width direction. Specifically, a drive signal feedback current wire 410a is disposed at a side of the first drive signal wire 402 opposite from the third drive signal wire 404 in the width direction. Also, a drive signal feedback current wire 410b is disposed at a side of the seventh drive signal wire 408 opposite from the fifth drive signal wire 406 in the width direction.

Formed at the second layer of the flexible electric wiring substrate 204 are a second drive signal wire 412, a fourth drive signal wire 414, a sixth drive signal wire 416, and an eighth drive signal wire 418, and these wires have almost the same wiring width (see FIG. 4B). The second drive signal wire 412, the fourth drive signal wire 414, the sixth drive signal wire 416, and the eighth drive signal wire 418 are arranged side by side in this order in the width direction of the flexible electric wiring substrate 204. Then, these drive signal wires are disposed in such a manner as to be sandwiched by two drive signal feedback current wires 420 in the width direction. Specifically, a drive signal feedback current wire 420a is disposed at a side of the second drive signal wire 412 opposite from the fourth drive signal wire 414 in the width direction. Also, a drive signal feedback current wire 420b is disposed at a side of the eighth drive signal wire 418 opposite from the sixth drive signal wire 416 in the width direction.

### <How a Piezoelectric Element is Driven and a Drive Signal for the Piezoelectric Element>

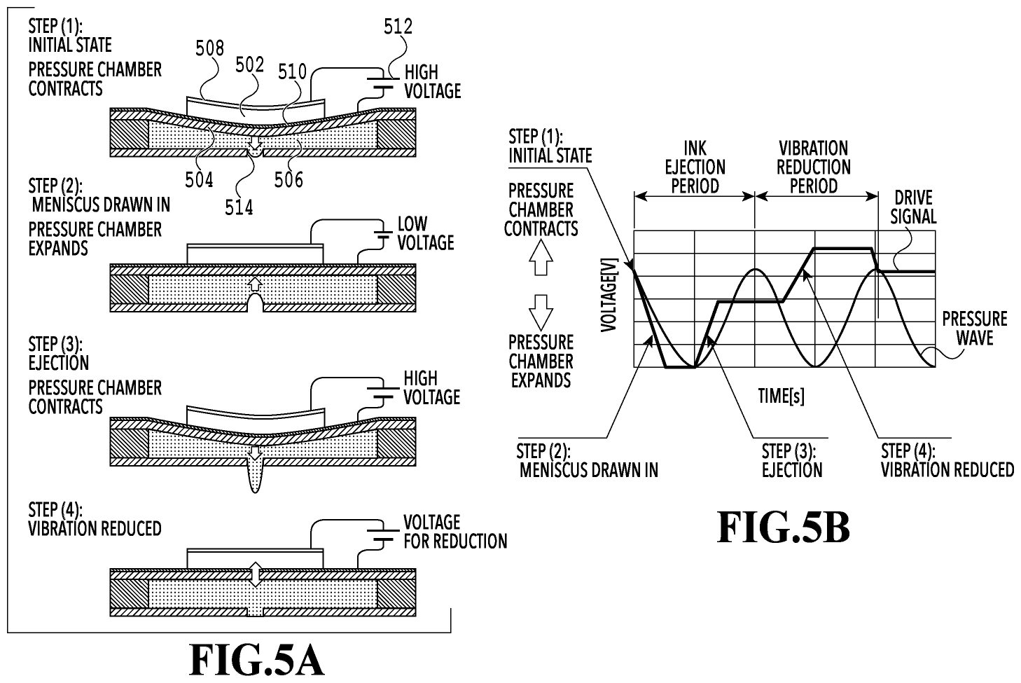

Next, a description is given of how a piezoelectric element 502 is driven and a drive signal to apply to the piezoelectric element 502. FIGS. 5A and 5B are diagrams illustrating how the piezoelectric element 502 is driven, FIG. 5A showing four steps of how the piezoelectric element 502 is driven, FIG. 5B showing a drive signal to apply to the piezoelectric element.

The following four steps, Steps (1) to (4), are executed to drive the piezoelectric element 502. Specifically, a series of operations in Steps (1) to Step (4) described below is a single round of ejection operation (see FIG. 5A). Also, a series of changes in the voltage from a voltage source 512 in Steps (1) to (4) form a waveform of a drive signal to be applied to the piezoelectric element 502 (see FIG. 5B).
Step (1): In the initial state, a pressure chamber 504 filled with ink 506 contracts upon application of a high voltage from the voltage source 512 between an upper electrode 508 and a lower electrode 510 of the piezoelectric element 502.
Step (2): The voltage from the voltage source 512 is lowered to expand the pressure chamber 504, and the ink 506 is drawn into the expanded pressure chamber 504 through a flow channel (not shown) communicating with the pressure chamber 504. In this event, a sinusoidal pressure wave is generated in the pressure chamber 504 by the piezoelectric element 502. Also, in this event, a meniscus inside a nozzle 514 is drawn toward the pressure chamber 504.
Step (3): In synchronization with the pressure wave generated in Step (2), the voltage of the voltage source 512 is raised to contract the pressure chamber 504, ejecting the ink 506 from the nozzle 514.
Step (4): After Step (3), a mechanical vibration continues in the piezoelectric element 502. To cancel this mechanical vibration out and make the piezoelectric element 502 still, the voltage of the voltage source 512 is raised again.

### <Configuration of the Printing Apparatus>

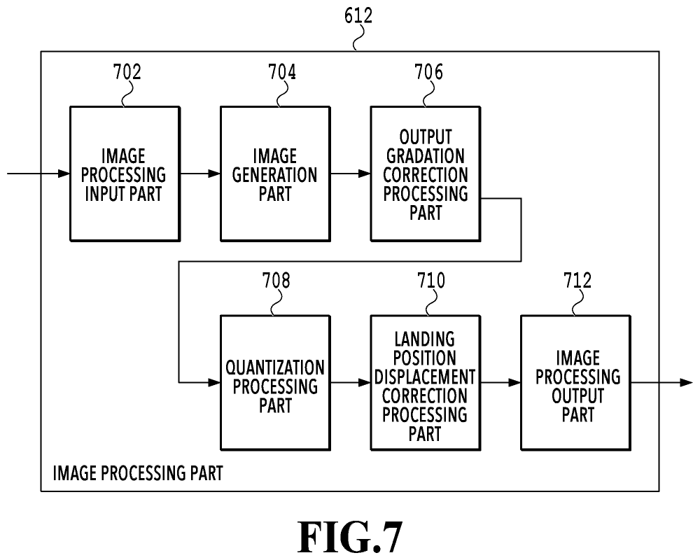

Next, the following describes the configuration of the printing apparatus 10, focusing on a control system. FIG. 6 is a block diagram showing the configuration of the printing apparatus. Note that FIG. 6 shows the configuration of the printing apparatus 10 focusing on the control system and thus omits part of the configuration of the printing apparatus 10. FIG. 7 is a block diagram showing a functional configuration of an image processing part 612.

The printing apparatus 10 has the controller 600 configured to control the overall operation of the printing apparatus 10. The controller 600 is connected to a host PC 602 and receives input of a print job outputted from the host PC 602, the print job including a print instruction, image data to be printed, print settings information, and the like. The controller 600 has a reception I/F 604, a ROM 606, a RAM 608, a motor/sensor control part 610, the image processing part 612, a print control part 614, and a CPU 615.

The reception I/F 604 transmits and receives data to and from the host PC 602. The ROM 606 stores programs for the CPU 615 to operate. The RAM 608 is used in execution of the programs and also temporarily stores various kinds of data. The motor/sensor control part 610 controls various motors and sensors in the printing apparatus 10.

The image processing part 612 performs image processing on image data included in a print job inputted from the host PC 602 through the reception I/F 604. Specifically, for example, the image processing part 612 generates raster image data in a bitmap format based on image data included in the inputted print job and described in page description language. The image processing part 612 further converts the generated image data into sets of image data for the respective ink colors, such as CMYK, processable by the print control part 614 and outputs them.

The print control part 614 performs print control of the printhead 22 based on the image data obtained by the image processing by the image processing part 612. The print control part 614 has a drive signal control part 616 and a drive signal selection information transmission part 618. The drive signal control part 616 outputs control signals (drive data) for generating drive signals to a drive signal generation part 620. The drive signal selection information transmission part 618 outputs drive signal selection information to the drive signal selection part 202 through serial communication using a predetermined transmission channel (referred to as first serial communication). Serial communication refers to a communication method where one or two transmission channels for transmitting and receiving data are used to transmit data one bit at a time successively.

The drive signal generation part 620 generates a plurality of drive signals based on control signals outputted from the drive signal control part 616 and outputs the generated drive signals to the drive signal selection part 202. Note that in the present embodiment, the plurality of drive signals include three drive signals (one for large ink droplet size, one for small ink droplet size, and one for no ejection of ink droplet).

The drive signal selection part 202 selects a drive signal to output to the printhead 22 from the plurality of drive signals outputted from the drive signal generation part 620 based on the drive signal selection information outputted from the drive signal selection information transmission part 618. The drive signal selected by the drive signal selection part 202 is inputted to the piezoelectric element 502 corresponding to the nozzle 514 in the chip unit 206 of the printhead 22. As described earlier, upon application of voltage having the drive signal waveform to the electrodes of the piezoelectric element 502, the piezoelectric element 502 between the electrodes changes in position, and the energy produced thereby causes ink to be ejected from the nozzle 514 (see FIG. 5A).

By the first serial communication, the drive signal selection information transmission part 618 and the drive signal selection part 202 are connected to each other, and a clk signal, a data signal, and a latch signal are transmitted from the drive signal selection information transmission part 618 to the drive signal selection part 202. Specifically, information is transmitted on a data signal in synchronization with a clk signal, the information being transmitted by a unit indicated by latch signals.

The drive signal selection information transmission part 618 and the drive signal selection part 202 are also connected to each other by second serial communication using a transmission channel different from the transmission channel used in the first serial communication. The second serial communication is used to configure settings inside the drive signal selection part 202. Although a communications protocol such as Serial Peripheral Interface (SPI) widely known is used for the second serial communication in the present example, the communication method is not limited to this.

The printhead 22 has the nozzles 514 configured to eject ink and the piezoelectric elements 502 provided in correspondence to the respective nozzles. Upon input of a drive signal to the piezoelectric element 502, ink is ejected from the nozzle 514. Although the following describes an example where the printhead 22 has 128 nozzles 514 and the piezoelectric elements 502 provided for the respective nozzles 514 unless otherwise noted, the number of nozzles 514 may be an integer which is 2 or greater.

In the image processing part 612, as instructed by the CPU 615, an image processing input part 702 reads image data included in a print job stored in the RAM 608 and outputs the image data to an image generation part 704 (see FIG. 7). The image generation part 704 converts the received image data to image data on each of four channels, CMYK, having the resolution printable by the printhead 22 and outputs the sets of image data to an output gradation correction processing part 706. The output gradation correction processing part 706 performs correction processing according to the ink's output characteristics. A quantization processing part 708 performs processing to convert the data represented in gradation levels in 8 bits to 16 bits to data in gradation levels representable by the nozzles of the printhead. Typically, the error diffusion method or the dither method is used to perform N-level quantization and convert the image data to have gradation levels represented by 1 bit to 4 bits. A landing position displacement correction processing part 710 shifts data on a pixel basis to correct displacement of the landing position of each nozzle in the unit of the resolution of an image. An image processing output part 712 performs processing to output the image data obtained by the above image processing to the RAM 608, and this image data is stored in the RAM 608.

### <Overview of the Configurations of the Drive Signal Selection Part and the Drive Signal Generation Part>

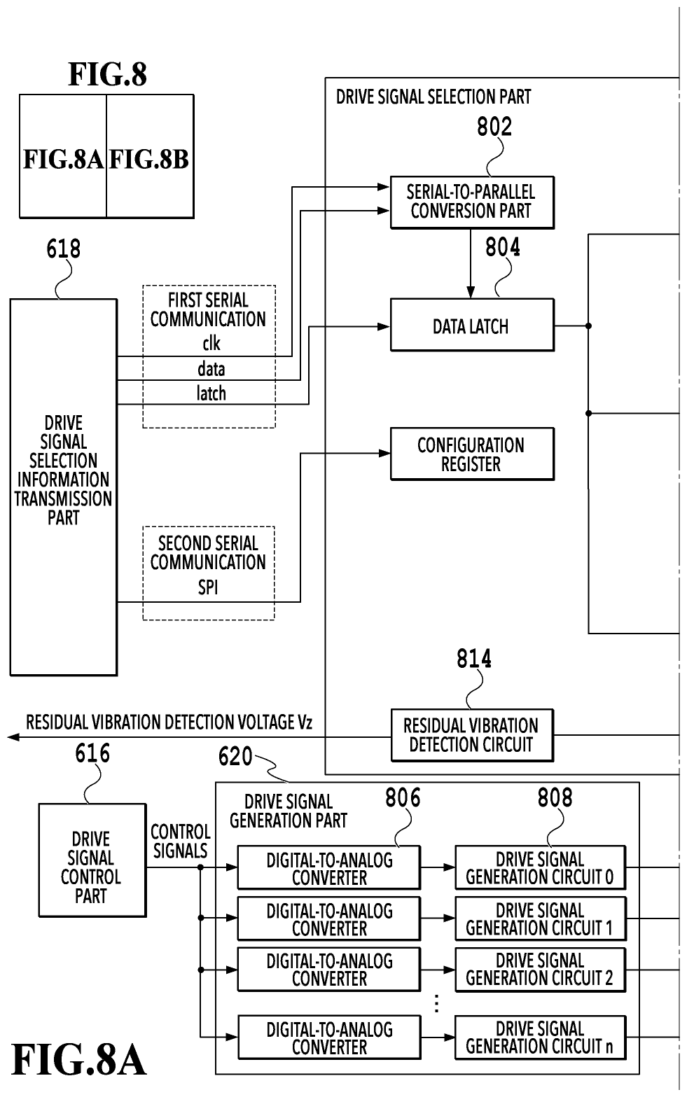

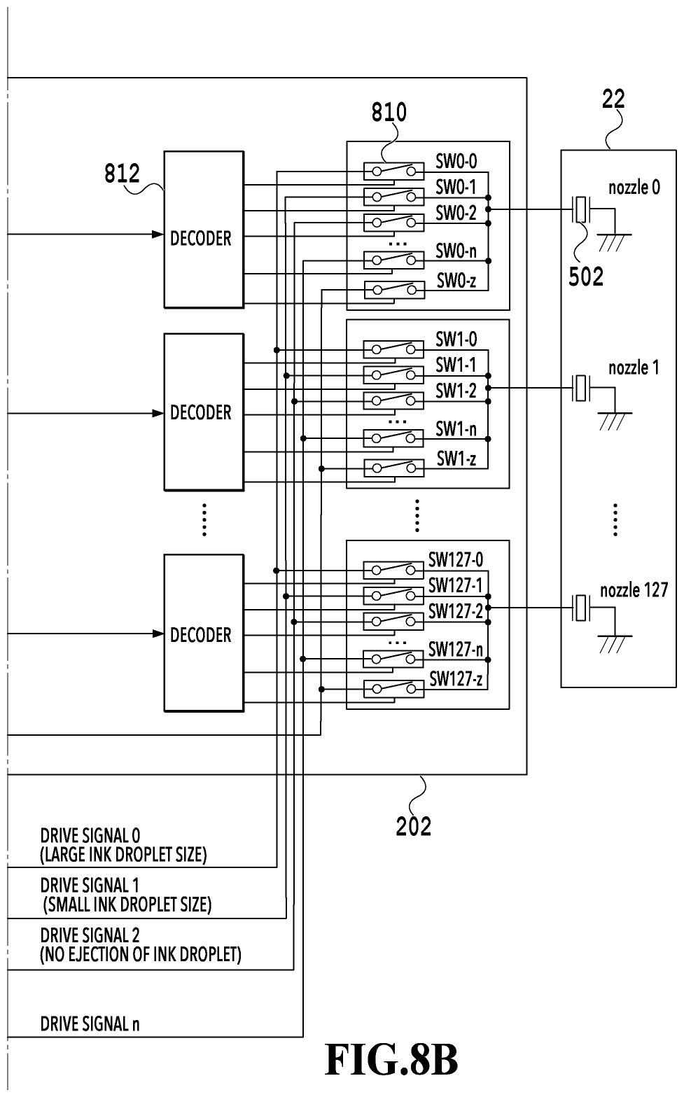

Next, an overview of the configurations of the drive signal selection part 202 and the drive signal generation part 620 is described. FIG. 8 is a schematic configuration diagram of the drive signal selection part 202 and the drive signal generation part 620. In the drive signal selection part 202, data transmitted from the drive signal selection information transmission part 618 through the first serial communication is received by a serial-to-parallel conversion part 802 and held at a data latch 804, starting from the timing at which a latch signal is inputted.

The drive signal generation part 620 has a plurality of digital-to-analog converts (DACs) 806 and a plurality of drive signal generation circuits 808. The DACs 806 each receive a control signal from the drive signal control part 616. An analog signal outputted from the DAC 806 is inputted to a corresponding one of the drive signal generation circuits 808, and the drive signal generation circuit 808 generates a drive signal based on the analog signal inputted thereto.

The drive signal generation circuit 808 outputs the generated drive signal to switch groups 810 provided in the drive signal selection part 202. The switch groups 810 are provided for the respective piezoelectric elements 502 provided in correspondence to the nozzles 514 provided at the printhead 22. Each switch group 810 is formed by a plurality of switches SWx-y, where “x” in SWx-y corresponds to a nozzle number identifying the nozzle 514, and “y” in SWx-y corresponds to a drive signal number identifying a drive signal.

The switch group 810 selects a particular one of a plurality of drive signals outputted from the drive signal generation circuits 808 based on decode information from a decoder 812 and outputs the particular drive signal to the corresponding piezoelectric element 502. As described earlier, the printhead 22 has a nozzle group including 128 nozzles 514 and the piezoelectric elements 502 provided for the respective nozzles 514. Thus, the drive signal selection part 202 is provided with the same number of decoders 812 and switch groups 810 as the nozzles 514.

### <First Serial Communication>

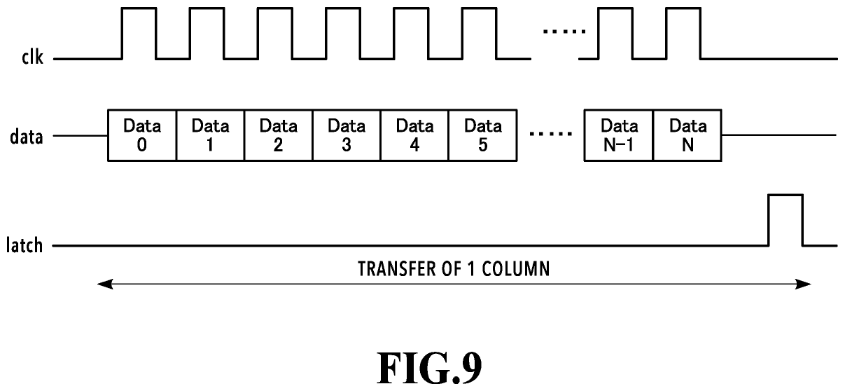

Next, the first serial communication is described. FIG. 9 shows signals transmitted from the drive signal selection information transmission part 618 by the first serial communication. As shown in FIG. 9, a data signal is transmitted in synchronization with a clk signal. A latch signal indicates the end of a single round of transmission. The data signal does not need to be one, and in order to be able to achieve ejection at a predetermined ink ejection frequency, there may be more data signals considering the balance with the frequency of the clk signal. Note that the “ink ejection frequency” refers to the number of times the printhead 22 ejects an ink droplet in one second.

In the present embodiment, communication is performed to be able to transmit a single column's worth of data, i.e., as many sets of data as the number of nozzles×the drive signal selection information (i.e., the number of types of drive signal), between a certain latch signal and the next latch signal. For example, in a case where there are four types of drive signal and 128 nozzles, data for 128×2 bits (which means selection from four types of signal) is transmitted between the latch signals. Also, in a case where there is a residual detection switch (to be described) in addition to the four types of drive signal, the sum of the number of types of drive signal and the number of residual detection switches is 5 (=4+1). Thus, data for 128×3 bits (to select from five states) needs to be transmitted between latch signals.

### <Timing Chart for the Drive Signal Selection Part>

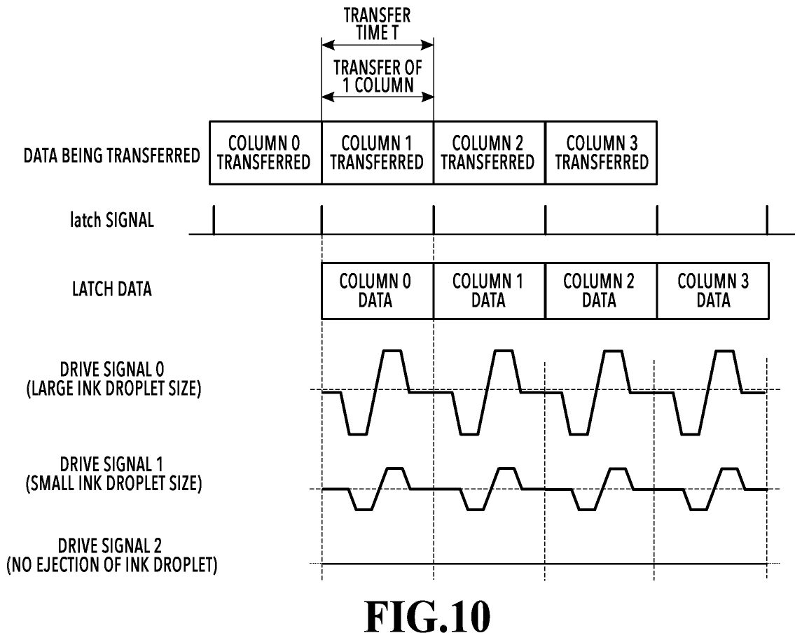

Next, a timing chart for the drive signal selection part is described with reference to FIG. 10. FIG. 10 is a diagram showing the relation between data transmitted by the first serial communication and drive signals. One column's worth of drive signal selection information is transmitted between a certain latch signal and the next latch signal, and the data received is held at the data latch 804 (see FIG. 8), starting from reception of a latch signal. Then, based on the data held at the data latch 804, one of the plurality of types of drive signal is selected for each nozzle 514 (piezoelectric element 502) and transmitted.

For example, the case in FIG. 10 assumes that there are three types of drive signal. Thus, in this case, there are three drive signal generation circuits 808 in FIG. 8 (a drive signal generation circuit 0, a drive signal generation circuit 1, and a drive signal generation circuit 2). These three drive signal generation circuits 808 are assigned drive signals for achieving respective desired ink droplet states, such as large ink drop size, small ink droplet size, and no ejection of ink droplet. Note that as shown in FIG. 10, a drive signal for achieving the state of large ink droplet size is defined as a “drive signal 0”; a drive signal for achieving the state of small ink droplet size, a “drive signal 1”; and a drive signal for achieving the state of no ejection of ink droplet, a “drive signal 2.”

### <Residual Vibration Detection Circuit>

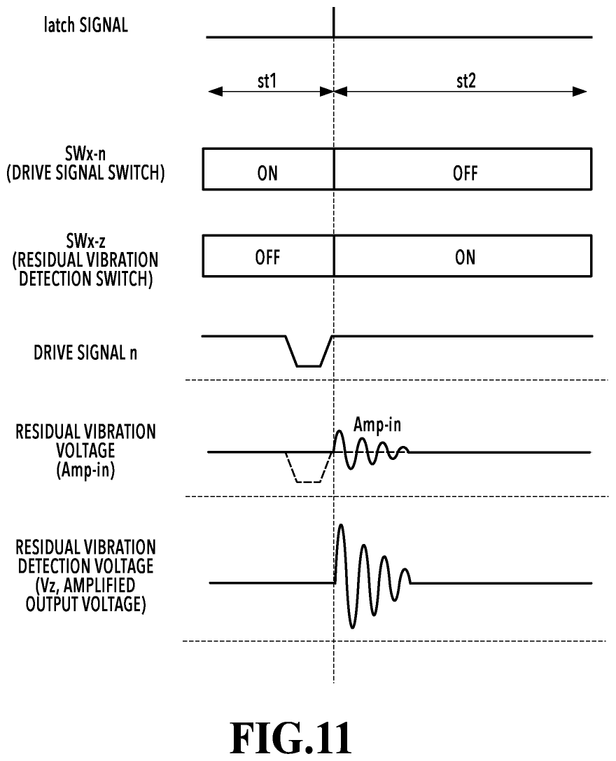

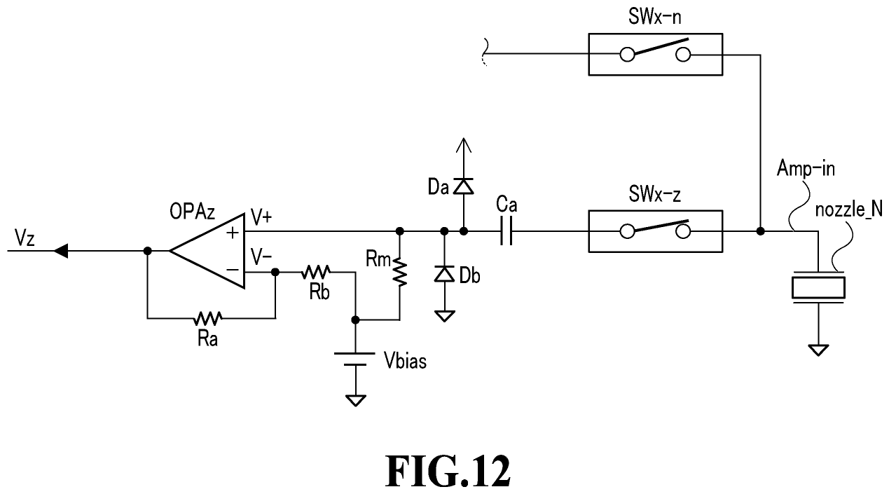

Next, a residual vibration detection circuit is described. FIG. 11 is a diagram showing a residual vibration voltage. FIG. 12 is a circuitry diagram of the residual vibration detection circuit.

Among the switches included in each switch group 810 shown in FIG. 8, switches SWx-0 to SWx-n (where x and n are each an integer which is 0 or greater and 127 or smaller in the present embodiment) are switches for applying a drive signal to the piezoelectric element 502 corresponding to the nozzle x. Also, among the switches included in the switch group 810, a switch SWx-z is a switch for supplying a residual vibration detection circuit 814 (see FIG. 8) with a residual vibration voltage generated at the piezoelectric element 502 by residual vibration caused after the piezoelectric element 502 is driven.

As shown in FIG. 11, first, in a zone st1, a drive signal is applied to the piezoelectric element 502, driving the piezoelectric element 502. After that, the switch is turned off to stop the application of the drive signal to the piezoelectric element 502. Then, as shown in FIG. 11, in a zone st2, a voltage Amp-in appears in the piezoelectric element 502. This voltage Amp-in is what the mechanical vibration remaining in the piezoelectric element 502 is converted into a voltage by a piezoelectric effect, and is called a “residual vibration voltage.” Detecting and analyzing the residual vibration volage enables detection of abnormality in each nozzle 514.

In the residual vibration detection circuit 814, the residual vibration voltage Amp-in is supplied to a non-inverting input terminal V+ of an operational amplifier OPAz through the switch SWx-z and a capacitor Ca (see FIG. 12). Also, in the residual vibration detection circuit 814, the non-inverting input terminal V+ of the operational amplifier OPAz is connected to a bias voltage Vbias through a resistance Rm. Meanwhile, an inverting input terminal V− of the operational amplifier OPAz is connected to the bias voltage Vbias through a resistance Rb. The inverting input terminal V− of the operational amplifier OPAz is also connected to the output terminal of the operational amplifier OPAz through a resistance Ra.

In the residual vibration detection circuit 814 with such a circuit configuration, the residual vibration voltage Amp-in is amplified into a residual vibration detection voltage Vz. The residual vibration detection voltage Vz is expressed by the following Formula (1).

$${V}_{Z} = \frac{{R}_{a} + {R}_{b}}{{R}_{b}} \cdot {Amp}_{- i n} + {V}_{bias} \qquad ( 1 )$$

The residual vibration detection voltage Vz is outputted to the outside of the residual vibration detection circuit 814 (see FIG. 8). After that, the residual vibration detection voltage Vz is converted into a digital signal by an analog-to-digital conversion device (not shown) and analyzed by a logical operation element (not shown).

### <Drive Signal Generation Circuit>

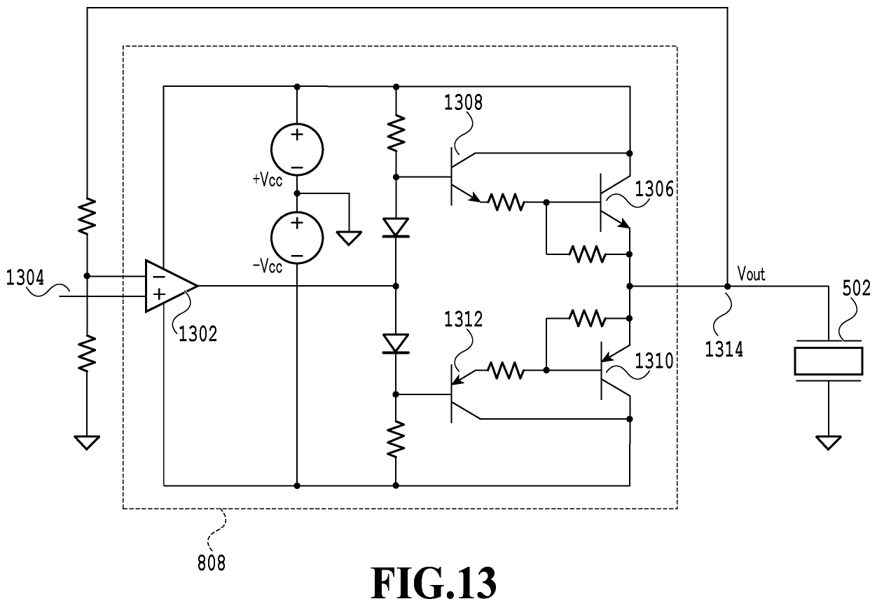

Next, the drive signal generation circuit 808 is described. FIG. 13 is a circuitry diagram of the drive signal generation circuit 808. The drive signal generation circuit 808 is what is called an amplification circuit and amplifies the voltage and current of an analog signal 1304 supplied to the non-inverting input terminal V+ of an operational amplifier 1302. The drive signal generation circuit 808 has transistors 1306, 1308 that are Darlington-connected at the high side, transistors 1310, 1312 that are Darlington-connected at the low side, and the operational amplifier 1302.

The transistors 1306, 1308 are each an npn transistor, and the transistors 1310, 1312 are each a pnp transistor. The base terminal of the transistor 1308 and the base terminal of the transistor 1312 are each connected to the output terminal of the operational amplifier 1302 through a diode. The emitter terminal of the transistor 1306 and the emitter terminal of the transistor 1310 are each connected to the piezoelectric element 502 through the switch SWx-n (not shown in FIG. 13).

Upon input of the analog signal 1304 to the drive signal generation circuit 808, the operational amplifier 1302 amplifies the voltage of the analog signal 1304. After that, the current of the analog signal 1304 is amplified by the transistors 1306, 1308 and the transistors 1310, 1312. Then, the piezoelectric element 502 is driven by a drive signal 1314 thus amplified in both voltage and current by the drive signal generation circuit 808, thereby causing ink to be ejected.

### <Detailed Configuration of the Drive Signal Generation Part>

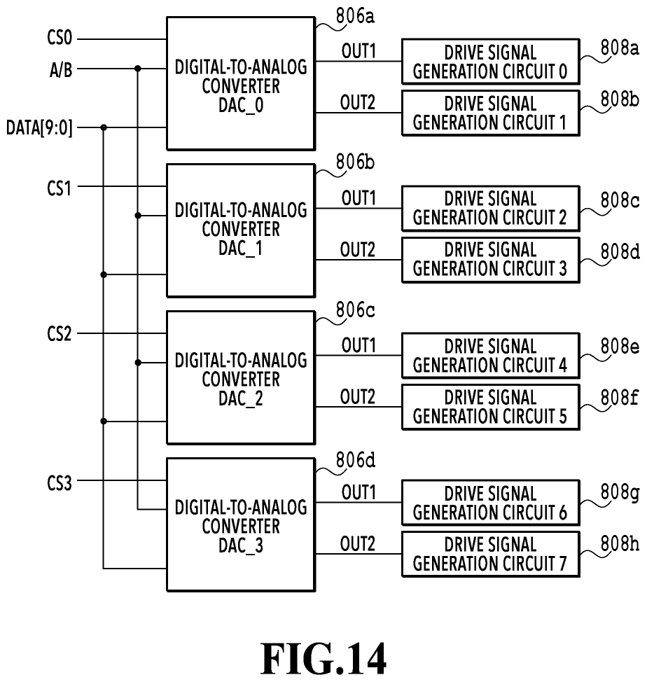

Next, a detailed configuration of the drive signal generation part 620 is described. FIG. 14 is a diagram showing a detailed configuration of the drive signal generation part 620. Note that the following describes an example where eight drive signals are supplied to a single printhead 22.

In the drive signal generation part 620, to generate eight drive signals for a single printhead 22, four DACs 806 are arranged side by side and are each connected to two drive signal generation circuits 808; thus, a total of eight drive signal generation circuits 808 are provided. More specifically, the drive signal generation part 620 includes DACs 806a, 806b, 806c, and 806d. Note that in the following description and the drawings, the DACs 806a, 806b, 806c, and 806d are also referred to as “DAC_0,” “DAC_1,” “DAC_2,” and “DAC_3,” respectively. Then, in the drive signal generation part 620, the drive signal generation circuits 808a and 808b are connected to the DAC 806a, and the drive signal generation circuits 808c and 808d are connected to the DAC 806b. Also, the drive signal generation circuits 808e and 808f are connected to the DAC 806c, and the drive signal generation circuits 808g and 808h are connected to the DAC 806d.

The DACs 806 are each a circuit configured to convert a value set by a digital signal into an analog value and outputs the analog value. Each DAC 806 can output two analog signals and receive input of DATA for setting an output value (a 10-bit parallel signal), a selection signal A/B for selecting and setting either an output signal OUT 1 or OUT 2, and a chip selection signal CS. DATA, A/B, and CS are outputted from the drive signal control part 616. DATA and A/B are connected in parallel to the DACs 806a, 806b, 806c, and 806d. The drive signal generation part 620 is configured to be able to control the four DACs 806 with control signals for a single DAC 806.

CS is connected individually to each DAC 806. Specifically, CS0 is connected to the DAC 806a, CS1 to the DAC 806b, CS2 to the DAC 806c, and CS3 to the DAC 806d. Output signals (OUT1, OUT2) from each DAC 806 are inputted to the respective drive signal generation circuits 808. Specifically, OUT1 from the DAC 806a is inputted to the drive signal generation circuit 808a, and OUT2 from the DAC 806a is inputted to the drive signal generation circuit 808b. OUT1 from the DAC 806b is inputted to the drive signal generation circuit 808c, and OUT2 from the DAC 806b is inputted to the drive signal generation circuit 808d. OUT1 from the DAC 806c is inputted to the drive signal generation circuit 808e, and OUT2 from the DAC 806c is inputted to the drive signal generation circuit 808f. OUT1 from the DAC 806d is inputted to the drive signal generation circuit 808g, and OUT2 from the DAC 806d is inputted to the drive signal generation circuit 808h.

### <Timings of Control Signals for the DACs>

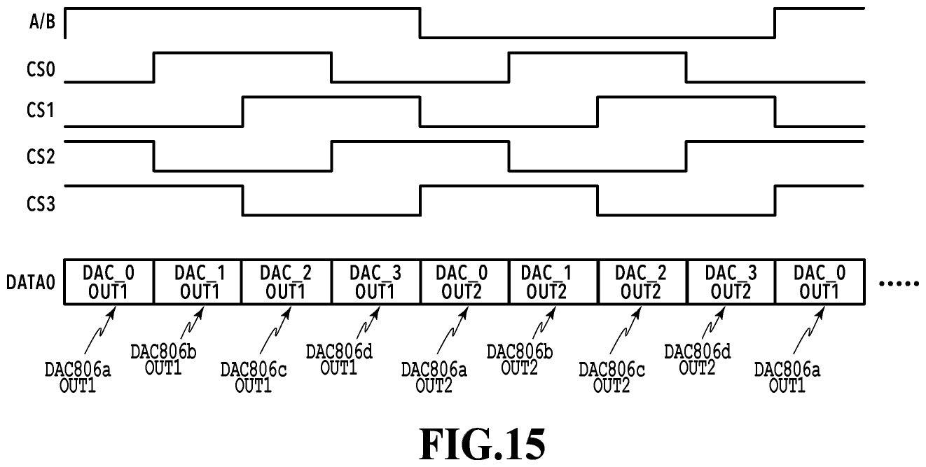

Next, the timings of control signals to the DACs 806 are described. FIG. 15 is a diagram illustrating the timings of control signals to the DACs 806. The DAC 806 is set to output OUT1 in a case where A/B is at high level and to output OUT2 in a case where A/B is at low level. At a rising edge of CS0, the DAC 806a (DAC_0 in FIG. 14) latches the setting of DATA0. Also, at a rising edge of CS1, the DAC 806b (DAC_1 in FIG. 14) latches the setting of DATA0. Further, at a rising edge of CS2, the DAC 806c (DAC_2 in FIG. 14) latches the setting of DATA0. Further, at a rising edge of CS3, the DAC 806d (DAC_3 in FIG. 14) latches the setting of DATA0.

The control signals A/B, CS0, CS1, CS2, CS3, and DATA0 are thus sequentially set, so that output signals from the DACs 806 are set in the following order: OUT1 from the DAC 806a→OUT1 from the DAC 806b→OUT1 from the DAC 806c→OUT1 from the DAC 806d→OUT2 from the DAC 806a→OUT2 from the DAC 806b→OUT2 from the DAC 806c→OUT2 from the DAC 806d. After OUT2 from the DAC 806d, the sequence returns to OUT1 from the DAC 806a, and the above-described sequence is repeated. As a result, there is no overlapping in the timings at which the DACs 806 output their output signals. Note that the above-described order is an example, and the timings of the control signals for the DACs may be in an order different from the one described above.

### <DAC Output Control>

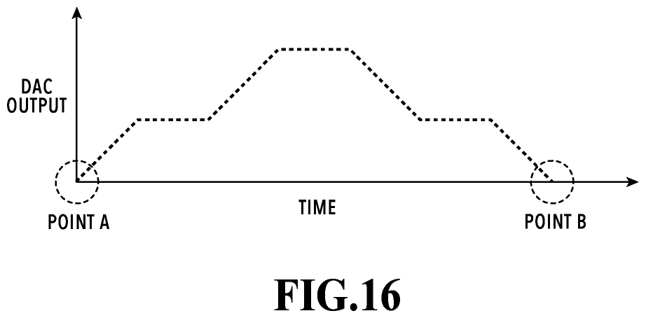

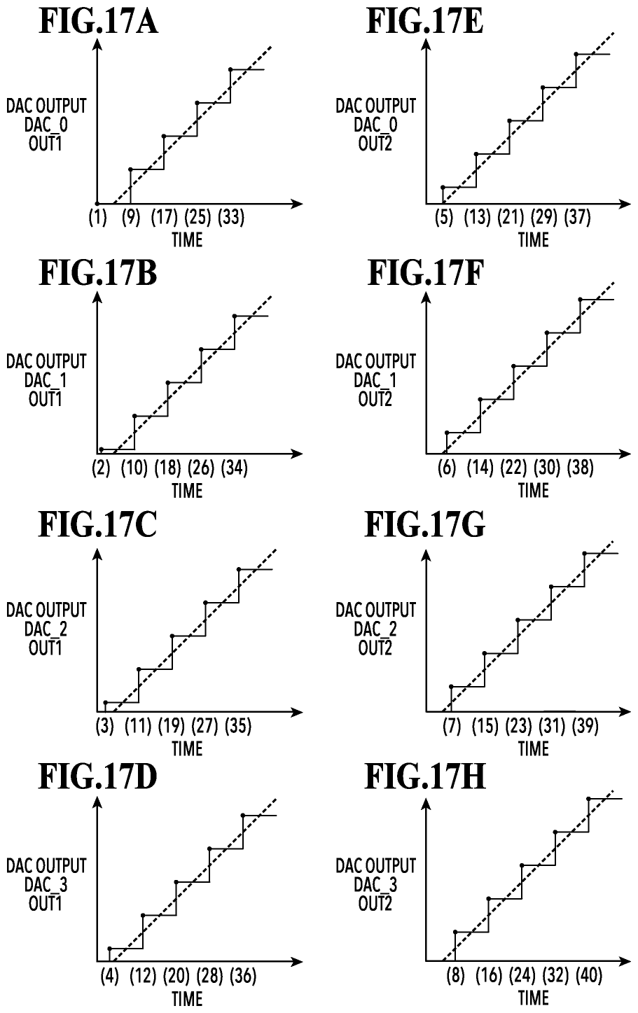

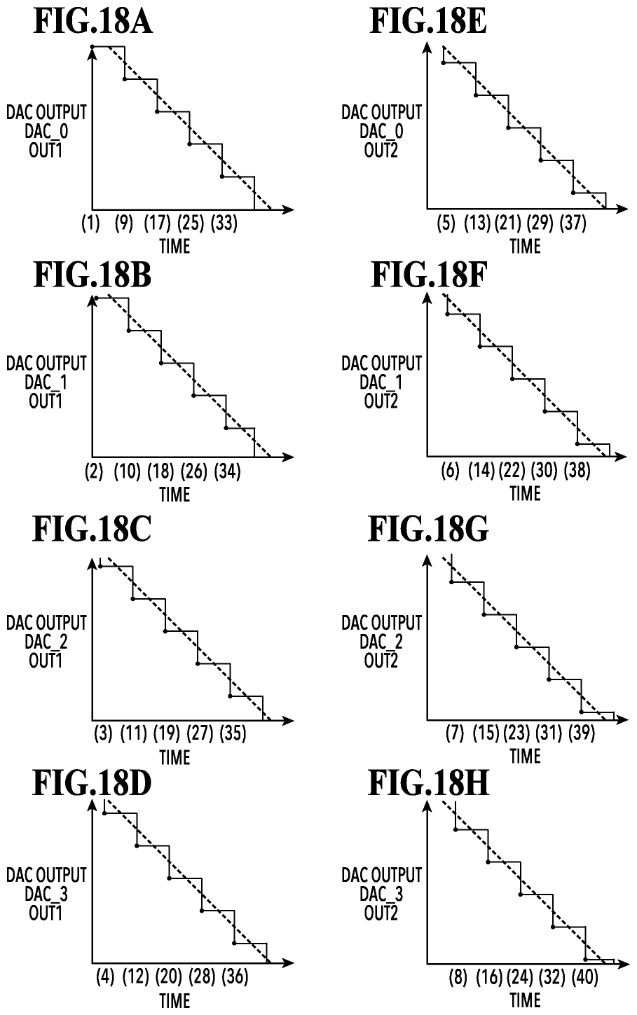

Next, control of an output from the DAC 806 is described. FIG. 16 shows an example waveform of an output from the DAC. FIGS. 17A to 17H are diagrams showing the relation between time and output values from the DACs 806 at a rising point of the output waveform in FIG. 16. FIGS. 18A to 18H are diagrams showing the relation between time and output values from the DACs 806 at a falling point of the output waveform in FIG. 16. Note that the broken lines in FIGS. 17A to 18H show an approximation curve of the DAC output values. The following describes an example where the DACs are controlled so that OUT1/OUT2 of the DACs 806 all describe the output waveform shown in FIG. 16.

As described above, the drive signal generation part 620 is configured to control the four DACs 806 with control signals for a single DAC 806. In other words, the drive signal generation part 620 is configured so that the DACs 806a, 806b, 806c, and 806d share control signals outputted from the drive signal control part 616. Thus, the drive signal generation part 620 forms the output waveform shown in FIG. 16 by sequentially switching the settings of the DACs 806.

At a rising point of the output waveform like a point A in FIG. 16, first, at timing (1) in FIG. 17A, the DAC 806a (DAC_0) is set to output from OUT1. Next, at timing (2) in FIG. 17B, the DAC 806b (DAC_1) is set to output from OUT1 an output value higher than the output value set immediately before at (1). Next, at timing (3) in FIG. 17C, the DAC 806c (DAC_2) is set to output from OUT1 an output value higher than the output value set immediately before at (2). Next, at timing (4) in FIG. 17D, the DAC 806d (DAC_3) is set to output from OUT1 an output value higher than the output value set immediately before at (3).

Next, at timing (5) in FIG. 17E, the DAC 806a is set to output from OUT2 an output value higher than the output value set immediately before at (4). Next, at timing (6) in FIG. 17F, the DAC 806b is set to output from OUT2 an output value higher than the output value set immediately before at (5). Next, at timing (7) in FIG. 17G, the DAC 806c is set to output from OUT2 an output value higher than the output value set immediately before at (6). Next, at timing (8) in FIG. 17H, the DAC 806d is set to output from OUT2 an output value higher than the output value set immediately before at (7).

Next, at timing (9) in FIG. 17A, the DAC 806a is set to output from OUT1 an output value higher than the output value set immediately before at (8). After that, an output value is similarly set to be higher than the one set immediately before according to the order described in the above section: Timings of Control Signals for the DACs. In this way, at a rising point of an output waveform, output values are set sequentially in the order of (1) to (40) in FIGS. 17A to 17H in such a manner that each output value is set to be higher than the one set immediately before.

Also, at a falling point of the output waveform like a point B in FIG. 16, first, at timing (1) in FIG. 18A, the DAC 806a (DAC_0) is set to output from OUT1 an output value lower than the output value set immediately before. Next, at timing (2) in FIG. 18B, the DAC 806b (DAC_1) is set to output from OUT1 an output value lower than the output value set immediately before at (1). Next, at timing (3) in FIG. 18C, the DAC 806c (DAC_2) is set to output from OUT1 an output value lower than the output value set immediately before at (2). Next, at timing (4) in FIG. 18D, the DAC 806d (DAC_3) is set to output from OUT1 an output value lower than the output value set immediately before at (3).

Next, at timing (5) in FIG. 18E, the DAC 806a is set to output from OUT2 an output value lower than the output value set immediately before at (4). Next, at timing (6) in FIG. 18F, the DAC 806b is set to output from OUT2 an output value lower than the output value set immediately before at (5). Next, at timing (7) in FIG. 18G, the DAC 806c is set to output from OUT2 an output value lower than the output value set immediately before at (6). Next, at timing (8) in FIG. 18H, the DAC 806d is set to output from OUT2 an output value lower than the output value set immediately before at (7).

Next, at timing (9) in FIG. 18A, the DAC 806a is set to output from OUT1 an output value lower than the output value set immediately before at (8). After that, an output value is similarly set to be lower than the one set immediately before according to the order described in the above section: Timings of Control Signals for the DACs. In this way, at a falling point of an output waveform, output values are set sequentially in the order of (1) to (40) in FIGS. 18A to 18H in such a manner that each output value is set to be lower than the one set immediately before. Note that at a constant part of the output waveform, an output value is set to be the same as the one set immediately before according to the order described in the above section: Timings of Control Signals for the DACs.

### Operations and Advantageous Effects

As described above, in the present embodiment, in the drive signal generation part configured to generate a plurality of drive signals for a single printhead, control signals for generating the drive signals are shared by a plurality of DACs, and each of the DACs outputs two output signals. This requires a fewer number of signal lines between the drive signal control part that outputs the control signals and the drive signal generation part that generates the plurality of drive signals based on the control signals than a publicly known technique, enabling size reduction of the circuit substrate including the drive signal control part and the drive signal generation part. Also, requiring fewer signal lines simplifies the wiring of the circuit substrate, enabling reduction in manufacturing cost.

Also, the DACs are set to output values at different timings. At a rising point of the output waveform, an output value is set to be higher than the one set immediately before, and at a falling point of the output waveform, an output value is set to be lower than the one set immediately before. This reduces shifting of the output waveforms of DAC outputs caused by being set at different timings.

### Second Embodiment

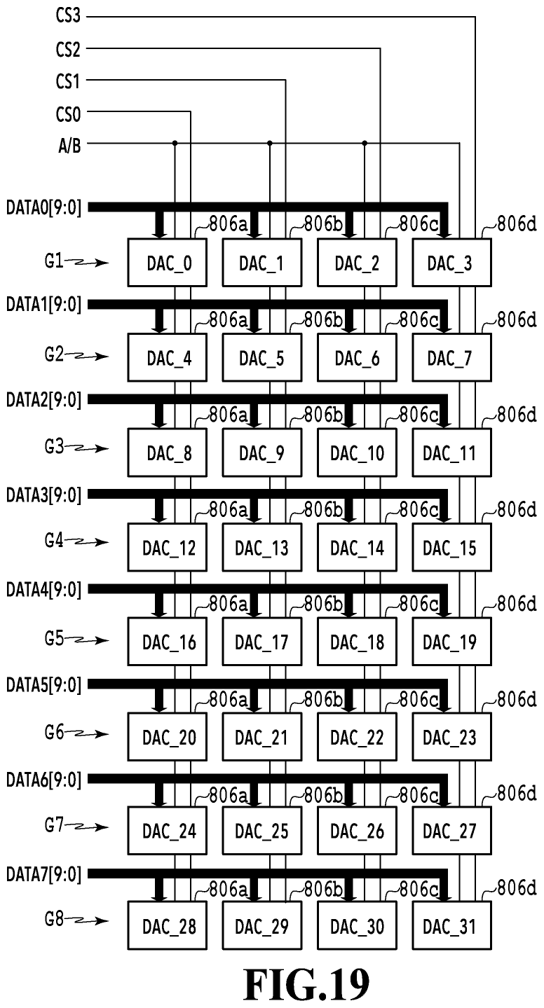

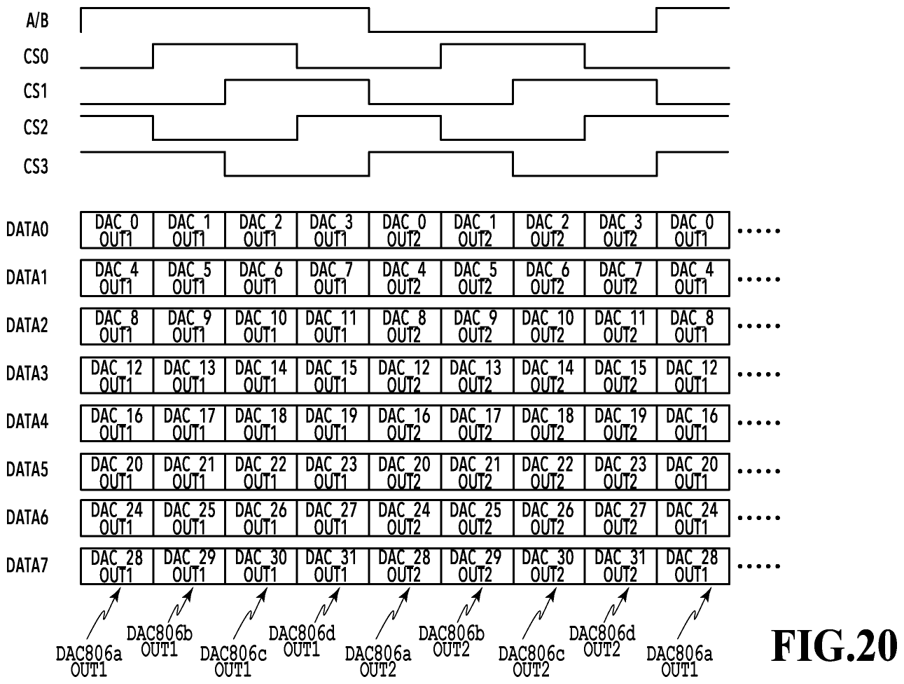

Next, a printing apparatus according to a second embodiment is described with reference to FIGS. 19 and 20. The following omits detailed descriptions of configurations that are the same as or equivalent to those in the printing apparatus of the first embodiment described above by using the same reference numerals as those used in the first embodiment described above.

In the first embodiment described above, the drive signal generation part 620 supplies a plurality of drive signals to a single printhead 22. By contrast to this case, in the second embodiment, the drive signal generation part is configured to supply a plurality of drive signals to each of a plurality of printheads. The drive signal generation part provided in the printing apparatus 10 of the present embodiment is described in detail below.

### <Detailed Configuration of the Drive Signal Generation Part>

FIG. 19 is a diagram showing a detailed configuration of the drive signal generation part 620 provided in the printing apparatus 10 of the present embodiment. Note that the following description given using FIG. 19 assumes a case where eight drive signals are supplied to eight printheads 22. Note that FIG. 19 shows a configuration of how input signals are connected to the DACs 806 and omits output signals from the DACs and the drive signal generation circuit.

In the present embodiment, to generate eight drive signals for each of the eight printheads 22, 32 DACs 806 are disposed at the drive signal generation part 620. Specifically, eight groups of four DACs 806a, 806b, 806c, and 806d are provided. In other words, a single group corresponds to a single printhead 22.

More specifically, a first group G1 includes DAC-0 as the DAC 806a, DAC_1 as the DAC 806b, DAC_2 as the DAC 806c, and DAC_3 as the DAC 806d. A second group G2 includes DAC_4 as the DAC 806a, DAC_5 as the DAC 806b, DAC_6 as the DAC 806c, and DAC_7 as the DAC 806d. A third group G3 includes DAC_8 as the DAC 806a, DAC_9 as the DAC 806b, DAC_10 as the DAC 806c, and DAC_11 as the DAC 806d. A fourth group G4 includes DAC_12 as the DAC 806a, DAC_13 as the DAC 806b, DAC_14 as the DAC 806c, and DAC_15 as the DAC 806d. A fifth group G5 includes DAC_16 as the DAC 806a, DAC_17 as the DAC 806b, DAC_18 as the DAC 806c, and DAC_19 as the DAC 806d. A sixth group G6 includes DAC_20 as the DAC 806a, DAC_21 as the DAC 806b, DAC_22 as the DAC 806c, and DAC_23 as the DAC 806d. A seventh group G7 includes DAC_24 as the DAC 806a, DAC_25 as the DAC 806b, DAC_26 as the DAC 806c, and DAC_27 as the DAC 806d. An eighth group G8 includes DAC_28 as the DAC 806a, DAC_29 as the DAC 806b, DAC_30 as the DAC 806c, and DAC_31 as the DAC 806d.

Note that although not shown, two drive signal generation circuits 808 are connected to each DAC, and each DAC outputs OUT1 and OUT2 to the respective drive signal generation circuits 808.

Also, DATA is connected in parallel to the four DACs in each group. Specifically, DATA0 is connected to DAC_0, DAC_1, DAC_2, and DAC_3 of the first group G1. DATA1 is connected to DAC_4, DAC_5, DAC_6, and DAC_7 of the second group G2. DATA2 is connected to DAC_8, DAC_9, DAC_10, and DAC_11 of the third group G3. DATA3 is connected to DAC_12, DAC_13, DAC_14, and DAC_15 of the fourth group G4. DATA4 is connected to DAC_16, DAC_17, DAC_18, and DAC_19 of the fifth group G5. DATA5 is connected to DAC_20, DAC_21, DAC_22, and DAC_23 of the sixth group G6. DATA6 is connected to DAC_24, DAC_25, DAC_26, and DAC_27 of the seventh group G7. DATA7 is connected to DAC_28, DAC_29, DAC_30, and DAC_31 of the eighth group G8. A/B is connected to all the DACs 806.

CS is connected to a corresponding DAC in each group. In other words, CS0 is connected to the DAC which is set first in each group. Specifically, CS0 is connected to DAC_0, DAC_4, DAC_8, DAC_12, DAC_16, DAC_20, DAC_24, and DAC_28. CS1 is connected to the DAC which is set second in each group. Specifically, CS1 is connected to DAC_1, DAC_5, DAC_9, DAC_13, DAC_17, DAC_21, DAC_25, and DAC_29. CS2 is connected to the DAC which is set third in each group. Specifically, CS2 is connected to DAC_2, DAC_6, DAC_10, DAC_14, DAC_18, DAC_22, DAC_26, and DAC_30. CS3 is connected to the DAC which is set fourth in each group. Specifically, CS3 is connected to DAC_3, DAC_7, DAC_11, DAC_15, DAC_19, DAC_23, DAC_27, and DAC_31.

### <Timings of Control Signals for the DACs>

Next, the timings of control signals to the DACs 806 are described. FIG. 20 is a diagram illustrating the timings of control signals to the DACs 806. The DAC 806 is set to output OUT1 in a case where A/B is at high level and to output OUT2 in a case where A/B is at low level.

At a rising edge of CS0, DAC_0 latches the setting of DATA0; DAC_4, DATA1; DAC_8, DATA2; DAC_12, DATA3; DAC_16, DATA4; DAC_20, DATA5; DAC_24, DATA6; and DAC_28, DATA7. At a rising edge of CS1, DAC_1 latches the setting of DATA0; DAC_5, DATA1; DAC_9, DATA2; DAC_13, DATA3; DAC_17, DATA4; DAC_21, DATA5; DAC_25, DATA6; and DAC_29, DATA7.

At a rising edge of CS2, DAC_2 latches the setting of DATA0; DAC_6, DATA1; DAC_10, DATA2; DAC_14, DATA3; DAC_18, DATA4; DAC_22, DATA5; DAC_26, DATA6; and DAC_30, DATA7. At a rising edge of CS3, DAC_3 latches the setting of DATA0; DAC_7, DATA1; DAC_11, DATA2; DAC_15, DATA3; DAC_19, DATA4; DAC_23, DATA5; DAC_27, DATA6; and DAC_31, DATA7.

In this way, control signals A/B, CS0, CS1, CS2, CS3, and DATA0 to DATA7 are sequentially set for the 32 DACs 806, so that output signals from the DACs 806 are set in the order below in each of the eight groups: OUT1 from the DAC 806a→OUT1 from the DAC 806b→OUT1 from the DAC 806c→OUT1 from the DAC 806d→OUT2 from the DAC 806a→OUT2 from the DAC 806b→OUT2 from the DAC 806c→OUT2 from the DAC 806d. After OUT2 from the DAC 806d, the sequence returns to OUT1 from the DAC 806a, repeating the order described above. As a result, there is no overlapping in the timings at which the DACs 806 output their output signals. Note that the above-described order is an example, and the timings of control signals for the DACs may be in an order different from the one described above.

### <DAC Output Control>

In regard to output control of the DACs 806, output values from the four DACs 806a, 806b, 806c, and 806d are set for each of the groups G1 to G8 similarly to the DAC output control described in the first embodiment above. A specific description of DAC output control for each group is the same as that described in the first embodiment above and is therefore omitted here.

### <Operations and Advantageous Effects>

As described above, in the present embodiment, in the drive signal generation part configured to generate a plurality of drive signals for a plurality of printheads, control signals for generating the drive signals are shared by a plurality of DACs corresponding to the respective printheads. Also, output setting is performed sequentially at timings different between a plurality of DACs corresponding to a single printhead. At a rising point of the output waveform, an output value is set to be higher than the one set immediately before, and at a falling point of the output waveform, an output value is set to be lower than the one set immediately before. This offers operations and advantageous effects similar to the first embodiment described above.

### OTHER EMBODIMENTS

Note that the embodiments described above may be modified as described as (1) to (3) below.
(1) In the embodiments described above, the printing apparatus 10 is configured to print on a sheet-shaped printing medium unwound from the roll R. However, the present disclosure is not limited to this. The printing apparatus 10 may be configured to print on a print medium of a predetermined size housed in a cassette or the like.
(2) In the embodiments described above, each DAC is capable of outputting two analog signals, and two drive signal generation circuits are connected to each DAC. However, the present disclosure is not limited to this. Each DAC may be capable of outputting three or more analog signals, and three or more drive signal generation circuits may be connected to each DAC.
(3) The embodiments described above and the various modes described above in (1) and (2) may be combined as needed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

According to the present disclosure, the number of signal lines is reduced, which contributes to a size reduction of the circuit substrate.

This application claims the benefit of Japanese Patent Application No. 2024-129899, filed Aug. 6, 2024, which is hereby incorporated by reference herein in its entirety.

What is claimed is:

1. A printing apparatus comprising:
a print unit configured to print by driving a piezoelectric element and ejecting ink;
a generation unit including a plurality of digital-to-analog converters and configured to generate a plurality of drive signals used to drive the piezoelectric element, the digital-to-analog converters being configured to convert a digital signal to an analog signal;
a control unit configured to output a control signal for generating the drive signals to the generation unit and control generation of the drive signals by the generation unit; and
a selection unit configured to select a particular one of the plurality of drive signals generated by the generation unit and outputs the particular drive signal to the print unit, wherein
in the generation unit,
the control signal is shared by the plurality of digital-to-analog converters, and
the plurality of digital-to-analog converters output output signals at different timings.

2. The printing apparatus according to claim 1, wherein
the plurality of digital-to-analog converters each output a plurality of analog signals.

3. The printing apparatus according to claim 2, wherein
the plurality of digital-to-analog converters share a selection signal for selecting which of the analog signals to output.

4. The printing apparatus according to claim 1, wherein
to raise output values from the digital-to-analog converters, the generation unit sets the output values outputted from the digital-analog-converters so that each output value is higher than an output value set immediately before.

5. The printing apparatus according to claim 1, wherein
to lower output values from the digital-to-analog converters, the generation unit sets the output values outputted from the digital-analog-converters so that each output value is lower than an output value set immediately before.

6. The printing apparatus according to claim 1, wherein
a plurality of the print units are provided, and
in the generation unit,
a predetermined number of digital-to-analog converters are connected to each of the plurality of print units, and
the control signal is shared by a group formed by the predetermined number of digital-to-analog converters.
